(19) United States
(12) Patent Application Publication
(10) Pub. No.: US 2025/0316296 A1
(43) Pub. Date: Oct. 9, 2025

(54) AUDIO AND VIDEO SYNCHRONIZATION DETECTION METHOD, DEVICE, ELECTRONIC EQUIPMENT AND TERMINAL

(71) Applicant: BEIJING BAIDU NETCOM SCIENCE TECHNOLOGY CO., LTD., Beijing (CN)

(72) Inventor: Xiangyang Wang, Beijing (CN)

(73) Assignee: BEIJING BAIDU NETCOM SCIENCE TECHNOLOGY CO., LTD., Beijing (CN)

(21) Appl. No.: 19/244,346

(22) Filed: Jun. 20, 2025

(30) Foreign Application Priority Data
Sep. 10, 2024 (CN) 202411266399.8

(51) Int. Cl. G11B 27/34; G06V 20/40; G06V 40/16; G10L 25/57

(52) U.S. Cl. CPC G11B 27/34; G06V 20/46; G06V 40/161; G06V 40/171; G10L 25/57

(57) ABSTRACT

An audio and video synchronization detection method includes: synchronously extracting first image frames and first audio frames from a video; obtaining a respective target type of each first image frame by performing type identification on the first image frames; determining a respective target audio and picture synchronization detection algorithm according to the respective target type; and performing audio and video synchronization detection on the first image frames and the first audio frames based on the respective target sound and picture synchronization detection algorithms.

### CROSS-REFERENCE TO RELATED APPLICATIONS

The present application is based on and claims the priority of Chinese patent application No. 2024112663998 filed on Sep. 10, 2025, the entire content of which is incorporated herein by reference.

### TECHNICAL FIELD

The disclosure relates to the technical field of image processing, specifically to the technical fields of computer vision and artificial intelligence, and in particular to an audio and video synchronization detection method, an audio and video synchronization detection apparatus, a related electronic device and a related terminal.

### BACKGROUND

In editing, encoding or playing a video, there may be a mismatch between a subtitle and an audio in the video, thus affecting a user viewing experience. In related arts, reference-based methods are often used for audio and video synchronization detection, for example adding tags or comparing with a reference video. Or non-reference methods may also be used for the audio and video synchronization detection.

### SUMMARY

According to a first aspect of the disclosure, an audio and video synchronization detection method is provided. The method includes: extracting first image frames and first audio frames from a video; obtaining a respective target type of each first image frame by identifying respective types of the first image frames; determining a respective target audio and video synchronization detection algorithm based on the respective target type; and performing audio and video synchronization detection on the first image frames and the first audio frames based on the respective target audio and video synchronization detection algorithms.

According to a second aspect of the disclosure, an electronic device is provided. The electronic device includes at least one processor and a memory communicatively connected to the at least one processor. The memory stores instructions executable by the at least one processor, and when the instructions are executed by the at least one processor, the at least one processor is caused to extract first image frames and first audio frames from a video; obtain a respective target type of each first image frame by identifying types of the first image frames; determine a respective target audio and video synchronization detection algorithm according to the respective target type; and perform audio and video synchronization detection on the first image frames and the first audio frames based on the target audio and video synchronization detection algorithms.

According to a third aspect of the disclosure, a non-transitory computer readable storage medium having computer instructions stored thereon is provided. The computer instructions are used to cause a computer to: extract first image frames and first audio frames from a video; obtain a respective target type of each first image frame by identifying types of the first image frames; determine a respective target audio and video synchronization detection algorithm according to the respective target type; and perform audio and video synchronization detection on the first image frames and the first audio frames based on the target audio and video synchronization detection algorithms.

### BRIEF DESCRIPTION OF THE DRAWINGS

The accompanying drawings are for better understanding this scheme and do not constitute as a limitation on the disclosure, in which:

FIG. 1 is a flowchart of an audio and video synchronization detection method of an embodiment of the disclosure.

FIG. 2 is a flowchart of an audio and video synchronization detection method of an embodiment of the disclosure.

FIG. 3 is a flowchart of an audio and video synchronization detection method of an embodiment of the disclosure.

FIG. 4 is a flowchart of an audio and video synchronization detection method of an embodiment of the disclosure.

FIG. 5 is a schematic diagram of an audio and video synchronization detection apparatus of an embodiment of the disclosure.

FIG. 6 is a schematic diagram of an electronic device of an embodiment of the disclosure.

FIG. 7 is a schematic diagram of a terminal of an embodiment of the disclosure.

### DETAILED DESCRIPTION

Exemplary embodiments of the disclosure are described below with reference to the accompanying drawings, in which various details of the embodiments of the disclosure are included to facilitate understanding, and they should be considered as exemplary only. Therefore, those skilled in the art should realize that various changes and modifications can be made to the embodiments described herein without departing from the scope and spirit of the disclosure. For clarity and brief, descriptions of well-known functions and structures are omitted in the following descriptions.

Image processing is a technology that uses computers to analyze images in order to achieve desired results. It is also known as picture processing or video processing. Image processing generally refers to digital image processing. A digital image is a large two-dimensional array obtained by photographing/imaging with industrial cameras, video cameras, scanners, etc. Elements of the array are called pixels, and their values are called gray-scale values. Image processing technology typically includes three parts: image compression, enhancement and restoration, and matching, description and recognition.

Computer vision is a science that studies how to enable machines to “see”. More specifically, it involves machine vision using cameras and computers to replace the human eyes for tasks such as target identifying, tracking and measurement and to further process images to make them more suitable for observation with human eyes or transmission to instruments for detection. As a scientific discipline, computer vision investigates related theories and technologies, aiming to establish an artificial intelligence system capable of obtaining “information” from images or multi-dimensional data. The term “information” here refers to Shannon-defined information that may be used to aid in making a “decision”. Since perception may be regarded as extracting information from sensory signals, computer vision may also be regarded as a science of enabling artificial systems to “perceive” from images or multi-dimensional data.

Artificial intelligence (AI) is a new technical science that studies and develops theories, methods, technologies and application systems for simulating, extending and expanding human intelligence.

In the embodiments of the disclosure, a video reading tool may be used to read a video to be processed using the audio and video synchronization detection. The video reading tool decodes the video and then performs the audio and video synchronization detection on the video to acquire an audio and video synchronization detection result for the video.

Video decoding formats include but are not limited to: (1) H.264/AVC (Advanced Video Coding), with the video decoder being libx264; (2) H.265/HEVC (High Efficiency Video Coding), with the video decoder being libx265; (3) VP8 (Video Coding Format by Google), with the video decoder being libvpx; (4) VP9 (Successor to VP8), with the video decoder being libvpx-vp9; (5) AV1 (AOMedia Video 1), with the video decoder being libaom-avl; (6) MPEG-2 (Moving Picture Experts Group Phase 2), with the video decoder being mpeg2video; (7) MPEG-4 (Moving Picture Experts Group Phase 4), with the video decoder being mpeg4; (8) Theora (Free and Open Video Codec), with the video decoder being libtheora; and ProRes (Apple ProRes), with the video decoder being prores; (10) DNxHD (Digital Nonlinear Extensible High Definition), with the video decoder being dnxhd; (11) WMV (Windows Media Video), with the video decoder being wmv2; (12) FLV1 (Flash Video), with the video decoder being fly; and (13) MJPEG (Motion JPEG), with the video decoder being mjpeg.

Audio decoding formats include but are not limited to: (1) AAC (Advanced Audio Coding), with the audio decoder being aac; (2) MP3 (MPEG-1 Audio Layer 3), with the audio decoder being libmp3lame; (3) Vorbis (Ogg Vorbis), with the audio decoder being libvorbis; (4) Opus (Audio Codec), with the audio decoder being libopus; (5) FLAC (Free Lossless Audio Codec), with the audio decoder being flac; (6) ALAC (Apple Lossless Audio Code), with the audio decoder being alac; (7) AC3 (Audio Codec 3), with the audio decoder being ac3; (8) WMA (Windows Media Audio), with the audio decoder being wmav2; (9) WAV (Waveform Audio File Format), with the audio decoder being built-in WAV decoder; (10) AMR (Adaptive Multi-Rate), with the audio decoders being libopencore_amrnb (NB) and libopencore_amrwb (WB); and (11) PCM (Pulse Code Modulation), with the audio decoders being pcm_sl61e, pcm_s241e, etc.

The basic processes of encoding and decoding a video are provided as follows. At the encoder, an image frame is divided into blocks, and intra prediction or inter prediction is performed on the current block to obtain a predicted block of the current block. The original block of the current block is subtracted by the predicted block to obtain a residual block, and the residual block is transformed and quantized to obtain a quantized coefficient matrix, which is subjected to entropy coding and output to a code stream. At the decoder, intra prediction or inter prediction is performed on the current block to obtain the predicted blocks for the current block, on the other hand, a quantized coefficient matrix is obtained by decoding the code stream, the quantized coefficient matrix undergoes inverse quantization and inverse transform to obtain the residual block, and the predicted block and the residual block are added to obtain a reconstruction block. The reconstruction blocks constitute a reconstruction image, and a decoded image is obtained by performing the in-loop filter on the reconstruction image based on the image or the blocks. The encoder also needs to perform similar operations to the decoder to obtain the decoded image. The decoded image may be used as a reference frame for subsequent inter prediction. Block division information, mode information such as prediction, transform, quantization, entropy coding, loop filtering, and parameter information determined by the encoder are output to the code stream if necessary. The decoder determines the same block division information, mode information such as prediction, transform, quantization, entropy coding and in loop filter or parameter information as the encoder by parsing and analyzing based on the existing information, so as to ensure that the decoded image obtained by the encoder is the same as that obtained by the decoder. Usually, the decoded image obtained by the encoder is also called a reconstruction image. The current block is divided into prediction units during prediction, the current block is divided into transform units during transformation, and the division to obtain the prediction units and the division to obtain the transform units are different. The basic processes of the video encoder and decoder under the block-based hybrid coding framework are described above. Some modules or steps of the framework or processes may be optimized with the development of technology. The embodiments of the disclosure are applicable to the basic processes under the block-based hybrid coding framework but are not limited to the framework or processes.

Currently, universal video coding standards adopt a block-based hybrid coding framework. Each frame in the video image is divided into square LCUs of the same size (such as 128×128, 64×64, etc.), and each LCU may further be divided into rectangular CUs based on rules. The CU may be divided into smaller PUs, TUs, etc. In detail, the coding framework may include prediction, transform, quantization, entropy coding, in loop filter and other steps. Prediction may be divided into intra prediction and inter prediction, and the inter prediction includes motion estimation and motion compensation. Because there is a strong correlation between adjacent pixels within one frame of a video image, the use of intra prediction in video coding technologies may eliminate spatial redundancy between adjacent pixels. However, since there is also strong similarity between adjacent frames in the video image, the use of inter prediction in the video coding technologies may eliminate temporal redundancy between adjacent frames, thereby improving the efficiency of encoding and decoding.

Video is composed of multiple images. To make the video to be watched smoothly, dozens or even hundreds of frames are included in the video per second, such as 24 frames per second, 30 frames per second, 50 frames per second, 60 frames per second, or 120 frames per second. As a result, there is significant temporal redundancy in the video, or in other words, there is a high degree of temporal correlation. Inter prediction leverages the time correlation to improve compression efficiency. Inter prediction often uses “motion” to exploit time correlation. A very simple “motion” model is that an object is located at a certain position in the image at a given moment, and after a certain period of time, it has moved to another position in the image at the current moment. This is the basic and commonly used translation motion in video coding. Inter prediction uses motion information to represent “motion”. Basic motion information includes the information of reference frame and motion vector (MV). The reference frame may also be understood as a reference picture. The encoder/decoder determines a reference frame/picture according to the information of the reference frame/picture and determines coordinates of the reference block according to MV information and coordinates of the current block. The coordinates of the reference block are used to locate the reference block in the reference image. Using the determined reference block as the prediction block is the most fundamental prediction method in inter prediction.

In editing, encoding or playing a video, there may be a mismatch between a subtitle and an audio in the video, thus affecting a user viewing experience. In related arts, reference-based methods are often used for audio and video synchronization detection, for example adding tags or comparing with a reference video. Or non-reference methods may also be used for the audio and video synchronization detection. However, audio and video detection results obtained through the above methods are often inaccurate, so how to improve accuracy and reliability of the audio and video synchronization detection has become a problem to be solved urgently.

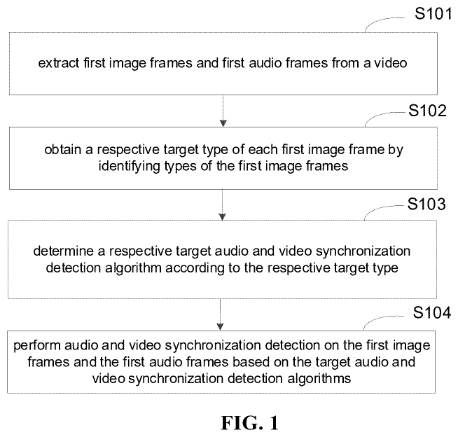

FIG. 1 is a flowchart of an audio and video synchronization detection method of an embodiment of the disclosure. As illustrated in FIG. 1, the method includes the following steps.

At step S101, first image frames and first audio frames are extracted from a video.

It should be noted that the execution subject of the audio and video synchronization detection method in the embodiments of the disclosure may be a hardware device having a data audio and video synchronization detection capability and/or necessary software required to drive the hardware device to operate. In some examples, the execution subject includes workstations, servers, computers, user terminals and other smart devices. The user terminal includes, but is not limited to, mobile phones, computers, smart voice interaction devices, smart home appliances, vehicle-mounted terminals, etc.

The video may be any video that needs to be subjected to audio and video synchronization detection.

For example, a video of any length read from a storage space may be regarded as a video that needs to be subjected to the audio and video synchronization detection. As another example, a preset length of a video may be intercepted as a video that needs to be subjected to the audio and video synchronization detection.

The video usually includes image frames and audio frames, and the image frames and audio frames are aligned on the time axis.

In the embodiments of the disclosure, the first image frames are extracted from the video at an interval and stored to an image list, and the first audio frames are extracted from the video at an interval and stored to an audio list.

It should be noted that the specific way to extract the first image frames from the video at an interval is not limited in the disclosure and may be selected according to actual situations.

In some examples, in a case that a preset interval is obtained, the first image frames {L₁ [symbol] L₂ [symbol] . . . Lₙ} are extracted from the video at the preset interval by using a video frame extraction tool, and the first audio frames {A₁ [symbol] A₂ [symbol] . . . Aₙ} are extracted from the video at the interval by using an audio extraction tool.

It should be noted that the setting of the interval is not limited in the disclosure and the interval may be set according to actual situations. For example, the interval may be set to 10 milliseconds or 30 milliseconds.

In the embodiments of the disclosure, after obtaining the first image frames, the first image frames {L₁ [symbol] L₂ [symbol] . . . Lₙ} are stored to an image list {L}. After obtaining the first audio frames, the first audio frames {A₁ [symbol] A₂ [symbol] . . . Aₙ} are stored to an audio list {A}.

At step S102, a respective target type of each first image frame is obtained by identifying respective types of the first image frames.

In the embodiments of the disclosure, content recognition is performed on each first image frame to determine whether there is a subtitle in each first image frame, and the respective target type of each image frame is obtained according to each content recognition result.

In some examples, in response to the existence of the subtitle in a first image frame, it is determined that the target type of the first image frame is a first type.

In some examples, in response to the absence of the subtitle in a first image frame, it is determined that the target type of the first image frame is a second type.

For example, for the first image frames L₁ and L₂, if the first image frame L₁ contains a subtitle, the target type of the first image frame L₁ is determined to be the first type. If there is no subtitle in the first image frame L₂, the target type of the first image frame L₂ is determined to be the second type.

At step S103, a respective target audio and video synchronization detection algorithm is determined according to the respective target type.

In the embodiments of the disclosure, after obtaining the respective target types of the first image frames, the respective target audio and video synchronization detection algorithms are determined according to the respective target types.

In the embodiments of the disclosure, in response to the target type being the first type, it is determined that the target audio and video synchronization detection algorithm is a subtitle-audio synchronization detection algorithm. In response to the target type being the second type, it is determined that the target audio and video synchronization detection algorithm is a labial-sound synchronization detection algorithm.

For example, in response to the target type of the first image frame L₁ being the first type, it is determined that the target audio and video synchronization detection algorithm is a subtitle-audio synchronization detection algorithm. In response to the target type of the first image frame L₂ being the second type, it is determined that the target audio and video synchronization detection algorithm is a labial-sound synchronization detection algorithm.

At step S104, an audio and video synchronization detection is performed on the first image frames and the first audio frames based on the respective target audio and video synchronization detection algorithms.

In some examples, if the target audio and video synchronization detection algorithm is the subtitle-audio synchronization detection algorithm, at least one second image frame with the same subtitle is determined from the first image frames, and second audio frame(s) synchronized with the second image frame(s) is/are determined from the first audio frames. Audio recognition result(s) of the second audio frame(s) is/are obtained, and the audio and video synchronization detection is performed on the first image frames and the first audio frames according to the same subtitle and the audio recognition result(s).

In some examples, if the target audio and video synchronization detection algorithm is the labial-sound synchronization detection algorithm, one or more face identifications are obtained by performing face detection and tracking on the first image frames, and a plurality of image lists are obtained by grouping the first image frames according to the face identification(s). Respective mouth region pictures corresponding to each image list are determined according to image frames in the respective image list, and the audio and video synchronization detection is performed on the first audio frames and the respective mouth region pictures corresponding to the image lists.

The audio and video synchronization detection method provided in the disclosure extracts the first image frames and the first audio frames from a video, identifies the respective type of each first image frame to obtain respective target types of the first image frames, determines respective target audio and video synchronization detection algorithms according to the respective target types, and then performs the audio and video synchronization detection on the first image frames and the first audio frames based on the respective target audio and video synchronization detection algorithms. The disclosure determines the target type of an image frame based on whether there is a subtitle in the first image frame and determines the target audio and video synchronization detection algorithm according to the target type of the image frame, which improves the flexibility and applicability of obtaining an audio and video synchronization detection result of the video. Based on the respective target audio and video synchronization detection algorithms, the audio and video synchronization detection is performed on the first image frames and the first audio frames, which improves the accuracy and reliability of obtaining the audio and video synchronization detection result of the video.

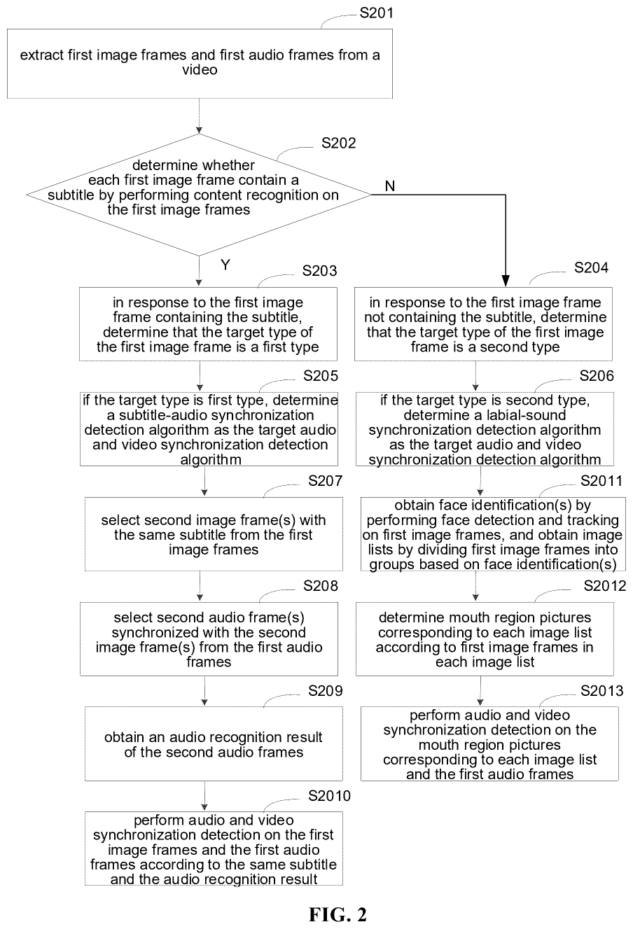

FIG. 2 is a flowchart of an audio and video synchronization detection method of a second embodiment of the disclosure.

As illustrated in FIG. 2, based on the embodiments of FIG. 1, the method includes the following steps.

At step S201, first image frames and first audio frames are extracted from a video.

The related contents of step S201 may refer to the above embodiments, and the details are not repeated here.

In detail, step S102 (i.e., “a respective target type of each first image frame is obtained by identifying respective types of the first image frames”) in the above embodiments include the following steps S202 to S204.

At step S202, for each first image frame, it is determined whether the first image frame contains a subtitle by performing content recognition on the first image frame.

In some examples, a pre-trained deep learning model performs content recognition on the first image frame to determine whether there is the subtitle in the first image frame.

At step S203, in response to the first image frame containing the subtitle, it is determined that the target type of the first image frame is a first type.

At step S204, in response to the first image frame not containing the subtitle, it is determined that the target type of the first image frame is a second type.

In detail, step S103 (i.e., “a respective target audio and video synchronization detection algorithm is determined according to the respective target type”) in the above embodiments include the following steps S205 and S206.

At step S205, in response to the target type being the first type, a subtitle-audio synchronization detection algorithm is determined as the target audio and video synchronization detection algorithm.

At step S206, in response to the target type being the second type, a labial-sound synchronization detection algorithm is determined as the target audio and video synchronization detection algorithm.

In the embodiments of the disclosure, in a case that the target audio and video synchronization detection algorithm is the subtitle-audio synchronization detection algorithm, step S104 (i.e., “audio and video synchronization detection is performed on the first image frames and the corresponding first audio frames based on the respective target audio and video synchronization detection algorithms”) includes the following steps S207 to S2010.

At step S207, at least one second image frame with the same subtitle is determined from the first image frames.

In the embodiments of the disclosure, the contents of the subtitles of the first image frames are extracted, and the second image frames with the same subtitle are determined and ranked according to the timestamps of the second image frames to obtain an image frame sequence.

It should be noted that the specific way to extract the contents of the subtitles of the first image frames is not limited in the disclosure and may be selected according to actual situations.

In some examples, a region where the subtitle is located is determined in the first image frame, and then the contents in the region of the first image frame are extracted by an Optical Character Recognition (OCR) technology.

In some examples, the first image frame may be input into a pre-trained subtitle text recognition model to extract the contents of the subtitle in the region of the first image frame.

In the embodiments of the disclosure, after the contents of the subtitles of the first image frames are obtained, the contents are compared to obtain a similarity between the contents, in order to determine the second image frames with the same subtitle.

For example, for the first image frame L₁, by extracting the contents of the subtitle of the first image frame L₁, it is determined that the subtitle of the first image frame L₁ is “It's sunny today”. After traversing the contents of the subtitles of remaining first image frames L₂, . . . , Lₙ, it is determined that the contents of the subtitles of the first image frame L₂ and the first image frame L₃ are the same as that of the first image frame L₁, and thus the first image frame L₂ and the first image frame L₃ are determined as the second image frames.

At step S208, second audio frames synchronized with the second image frames are determined from the first audio frames.

In the embodiments of the disclosure, the timestamps of the second image frames and the timestamps of the first audio frames are determined, start and end timestamps of the same subtitle are determined according to the timestamps of the second image frames, and second audio frames synchronized with the second image frames are determined from the first audio frames according to the start and end timestamps and the timestamps of the first audio frames.

It should be noted that a first one of the second image frames and a last one of the second image frames in the image frame sequence are determined, and the timestamp of the first one of the second image frames is determined as the start timestamp of the same subtitle, and the timestamp of the last one of the second image frames is determined as the end timestamp of the same subtitle.

In some examples, the start timestamp and the end timestamp of the same subtitle are determined based on start and end timestamps, the audio frame with a timestamp same as the start timestamp is determined as a first one of second audio frames from the audio list corresponding to the first audio frames, the audio frame with a timestamp same as the end timestamp is determined as a last one of second audio frames from the audio list corresponding to the first audio frames, and the audio frames starting from the first one of second audio frames to the last one of second audio frames are determined as the second audio frames.

At step S209, an audio recognition result of the second audio frames is obtained.

It should be noted that the specific way to obtain the audio recognition result of the second audio frames is not limited in the disclosure and may be selected according to actual situations.

In some examples, the second audio frames are combined in a time sequence to obtain an audio frame sequence, and the audio frame sequence is input into an audio recognition model to obtain the audio recognition result of the second audio frames.

At step S2010, audio and video synchronization detection is performed on the first image frames and the first audio frames according to the same subtitle and the audio recognition result.

In the embodiments of the disclosure, a similarity between the same subtitle and the audio recognition result may be obtained, and the audio and video synchronization detection is performed according to the similarity and a preset similarity (a similarity threshold).

In some examples, the same subtitle and the audio recognition result are input into a pre-trained subtitle-audio similarity detection model for cross-modal similarity calculation, in order to obtain the similarity between the same subtitle and the audio recognition result.

It should be noted that the value of the preset similarity is not limited by the disclosure. For example, the preset similarity may be 100% or 98%.

In some examples, in response to the similarity between the same subtitle and the audio recognition result being greater than the preset similarity, it is determined that the video is audio-video synchronized.

For example, for a video A, if the preset similarity is 98% and the similarity between the same subtitle and the audio recognition result is 100%, it is determined that video A is audio-video synchronized.

In some examples, in response to the similarity between the same subtitle and the audio recognition result being less than or equal to the preset similarity, it is determined that the video is audio-video unsynchronized.

For example, for video A, if the preset similarity is 98% and the similarity between the same subtitle and the audio recognition result is 90%, it is determined that video A is audio-video unsynchronized.

In the embodiments of the disclosure, if the target audio and video synchronization detection algorithm is the labial-sound synchronization detection algorithm, step S104 (i.e., “audio and video synchronization detection is performed on the first image frames and the corresponding first audio frames based on the respective target audio and video synchronization detection algorithms”) in the above embodiments include the following steps S2011 to S2013.

At step S2011, one or more face identifications are obtained by performing face detection and tracking on the first image frames, and a plurality of image lists are obtained by dividing the first image frames into groups according to the face identifications.

In some examples, the first image frames are input into a pre-trained face detection model for face detection to obtain faces in the image frames.

It should be noted that to improve the efficiency of audio and video detection, a respective area of each face detected in an image frame is obtained, and a face whose area is less than or equal to a preset value (such as a preset face detection area threshold) is removed to obtain final (candidate) faces in the image frame.

In some examples, after the final faces in the image frame are obtained, one or more face identifications (or Identity Documents, IDs) may be obtained by tracking the faces.

In the embodiments of the disclosure, after the face identifications are obtained, the face identifications are shown in the image frame, and the image frames are divided into groups according to the face identifications to obtain a plurality of image lists {F_{1,} F_{2,} . . . Fᵢ}.

For example, for a face identification ID1, image frames containing the face ID1 are determined from the image frames and grouped as a group to obtain an image list F₁, and for a face identification ID2, image frames containing the face ID2 are determined from the image frames and grouped as a group to obtain an image list F₂.

At step S2012, respective mouth region pictures corresponding to each image list is determined according to first image frames in each image list.

It should be noted that the specific way of determining the respective mouth region pictures corresponding to each image list according to the image frames in each image list is not limited in the disclosure and may be selected according to actual situations.

In some examples, the first image frames in each image list are input into the pre-trained facial feature extraction model for feature extraction to obtain the respective mouth region pictures corresponding to each image list.

For example, for the image list F₁, the first image frames in the image list F₁ are input into the pre-trained facial feature extraction model to extract the features of these first image frames, in order to obtain mouth region pictures M₁ corresponding to the image list F₁. For the image list F₂, the first image frames in the image list F₂ are input into the pre-trained facial feature extraction model to extract the features of these first image frames, in order to obtain mouth region pictures M₂ corresponding to the image list F₂.

At step S2013, audio and video synchronization detection is performed on the first audio frames and the mouth region pictures corresponding to image lists.

In the embodiments of the disclosure, audio feature extraction is performed on the first audio frames to obtain an audio feature sequence of the first audio frames. For each image list, lip motion feature extraction is performed on the mouth region pictures corresponding to the image list to obtain a lip motion feature sequence corresponding to the image list. A respective labial-sound similarity corresponding to each image list is obtained according to the respective lip motion feature sequence corresponding to each image list and the audio feature sequence, and audio and video synchronization detection is performed on the video according to the labial-sound similarities corresponding to the image lists.

In the embodiments of the disclosure, before extracting the audio features of the first audio frames to obtain the audio feature sequence of the audio frames, mouth key points are extracted from the mouth region pictures in the mouth region picture sequence, and a motion trajectory of the mouth key points is obtained by tracking the mouth key points. If the motion trajectory exhibits an opening and closing change, it is determined that the mouth is in a lip-moving state.

When it is determined that the mouth is in a lip-moving state, it is considered that the mouth is “speaking”.

In the embodiments of the disclosure, after the first audio frames {A₁ [symbol] A_{2,} . . . . Aₙ} are obtained, the first audio frames are ranked according to their timestamps to obtain the first audio frame sequence {A_{t1,} Aₜ₂, . . . . Aₜₙ}. By extracting audio features of the first audio frame sequence, an audio feature sequence {A′_{t1,} A′_{t2,} . . . . A′ₜₙ} of the first audio frames is obtained.

It should be noted that the specific way to obtain the respective lip motion feature sequence corresponding to the image list by extracting the lip motion features of the mouth region pictures corresponding to the image list is not limited in the disclosure and may be selected according to actual situations.

In some examples, for each image list, the mouth region pictures corresponding to the image list are ranked according to their timestamps to obtain a mouth region picture sequence, and a lip motion feature sequence corresponding to the image list is obtained by extracting lip motion features of the mouth region picture sequence.

For example, for each image list, the mouth region picture sequence is input into a pre-trained lip motion detection model for lip motion feature extraction to obtain the lip motion feature sequence corresponding to the image list.

It should be noted that the specific way to obtain the labial-sound similarity corresponding to the image list according to the lip motion feature sequence corresponding to the image list and the audio feature sequence is not limited in the disclosure and may be selected according to actual situations.

In some examples, for each image list, the lip motion feature sequence and the audio feature sequence corresponding to the image list are input into a pre-trained labial-sound synchronization detection model for cross-modal similarity calculation to obtain a labial-sound similarity corresponding to the image list.

In the embodiments of the disclosure, after obtaining the respective labial-sound similarity corresponding to each image list, audio and video synchronization detection is performed for the video according to the labial-sound similarities corresponding to the image lists.

In some examples, a preset similarity threshold is determined, and for each image list, whether the labial-sound similarity corresponding to the image list is greater than the similarity threshold may be determined, a statistical count of image lists each with labial-sound similarity greater than or equal to the similarity threshold is obtained. The audio and video synchronization detection may be performed on the video based on the statistical count.

It should be noted that the setting of the similarity threshold is not limited in the disclosure and may be set according to actual situations.

In the embodiments of the disclosure, a preset quantity threshold is determined, and the audio and video synchronization detection may be performed on the video based on the statistical count and the preset quantity threshold.

It should be noted that the setting of the preset quantity threshold N is not limited by the disclosure. For example, the preset quantity threshold N may be 1.

In some examples, in response to the statistical count being greater than or equal to the quantity threshold, the video is determined to be audio-video synchronized.

For example, if the statistical count n is 2 and the preset quantity threshold N is 1, that is, the statistical count is greater than the quantity threshold, the video is determined to be audio-video synchronized.

In some examples, in response to the statistical count being less than the quantity threshold, the video is determined to be audio-video unsynchronized.

For example, if the statistical count n is 0 and the preset quantity threshold N is 1, that is, the statistical count is less than the quantity threshold, the video is determined to be audio-video unsynchronized.

In conclusion, the audio and video synchronization detection method provided in the embodiments of the disclosure determines, for each first image frame, whether the first image frame contains a subtitle by performing content recognition on the first image frame. When there is a subtitle in some first image frames, the subtitle-audio synchronization detection algorithm is determined as the target audio and video synchronization detection algorithm. By determining the at least one second image frame with the same subtitle from these first image frames, it makes full use of information in the subtitles of the video to carry out the audio and video synchronization detection on the video according to the second image frames and the second audio frames synchronized with the second image frames. Determining whether the video is audio-video synchronized according to the similarity between the same subtitle and the audio recognition result and according to the preset similarity avoids the problem of miss detection in the audio and video synchronization detection process and improves the accuracy and reliability of the audio and video synchronization detection result of the video. When there is no subtitle in some first image frames, the labial-sound synchronization detection algorithm is determined as the target audio and video synchronization detection algorithm, and these image frames are divided into groups according to the face IDs to obtain the plurality of image lists, which solves the problem of audio and video out-of-synchronization detection in scenarios involving many people. Performing audio and video synchronization detection on the video according to the labial-sound similarities corresponding to the image lists avoids the problem of miss detection in the process of audio and video synchronization detection, improves the accuracy and reliability of the audio and video synchronization detection result of the video, and improves user experience when watching the video.

The specific process of audio and video synchronization detection on the first image frames and the first audio frames based on the respective target audio and video synchronization detection algorithms provided in the embodiments of the disclosure will be explained below.

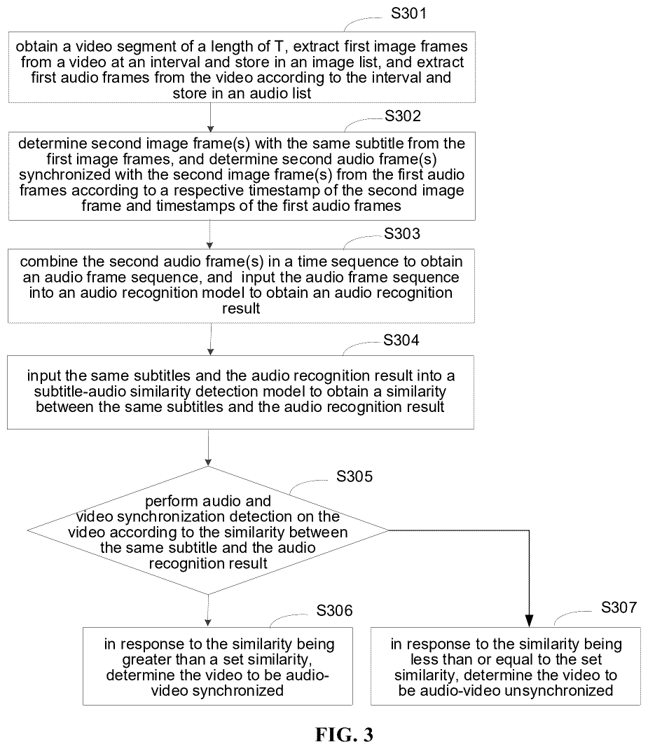

In the embodiments of the disclosure, if the target audio and video synchronization detection algorithm is subtitle-audio synchronization detection algorithm, as illustrated in FIG. 3, step S104 (i.e., “audio and video synchronization detection is performed on the first image frames and the corresponding first audio frames based on the target audio and video synchronization detection algorithms”) in the above embodiments includes the following steps S301 to S307.

At step S301, a video segment of a length of T is obtained, first image frames are extracted from a video at an interval and stored in an image list, and first audio frames are extracted from the video according to the interval and stored in an audio list.

At step S302, at least one second image frame with the same subtitle is determined from the first image frames, and second audio frames synchronized with the second image frames are determined from the first audio frames according to the timestamps of the second image frames and timestamps of the first audio frames.

At step S303, the second audio frames are combined in a time sequence to obtain an audio frame sequence, and the audio frame sequence is input into an audio recognition model to obtain an audio recognition result.

At step S304, the same subtitle and the audio recognition result are input into a subtitle-audio similarity detection model to obtain a similarity between the same subtitle and the audio recognition result.

At step S305, audio and video synchronization detection is performed on the video (i.e., it is determined whether the video is audio-video synchronized) according to the similarity between the same subtitle and the audio recognition result.

At step S306, in response to the similarity being greater than a set similarity (threshold), the video is determined to be audio-video synchronized.

At step S307, in response to the similarity being less than or equal to the set similarity (threshold), the video is determined to be audio-video unsynchronized.

In conclusion, the audio and video synchronization detection method provided in the disclosure determines the subtitle-audio synchronization detection algorithm as the target audio and video synchronization detection algorithm if it determines that there is a subtitle in the first image frames. The second image frames with the same subtitle are determined from these first image frames, and the audio recognition result of the second audio frames synchronized with the second image frames is obtained. The same subtitle and the audio recognition result are input into the subtitle-audio similarity detection model to obtain the similarity between the same subtitle and the audio recognition result. Determining whether the video is audio-video synchronized according to the similarity between the same subtitle and the audio recognition result avoids the problem of miss detection in the process of audio and video synchronization detection, prevents the problem of secondary detection caused by miss detection in the previous process. The method reduces the cost in the process of audio and video synchronization detection, improves the efficiency of audio and video synchronization detection, ensures the accuracy and reliability of the obtained audio and video synchronization detection result of the video, improves user experience when watching the video, and has a wide application range.

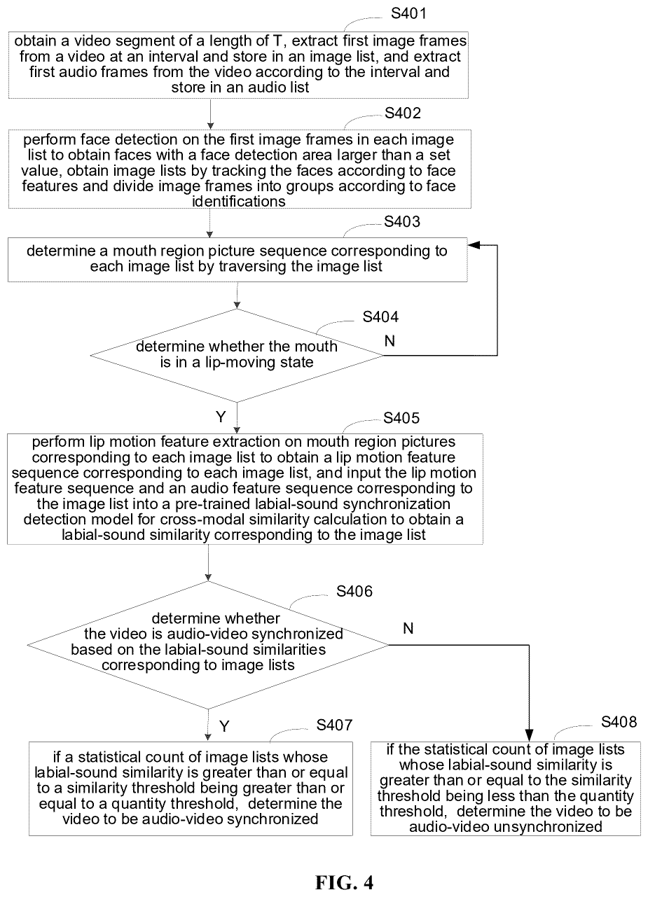

In the embodiments of the disclosure, if the target audio and video synchronization detection algorithm is the labial-sound synchronization detection algorithm, as illustrated in FIG. 4, step S104 (i.e., “audio and video synchronization detection is performed on the first image frames and the corresponding first audio frames based on the target audio and video synchronization detection algorithms”) in the above embodiment includes the following steps S401 to S408.

At step S401, a video segment of a length of T is obtained, first image frames are extracted from a video at an interval and stored in an image list, and first audio frames are extracted from the video according to the interval and stored in an audio list.

At step S402, face detection is performed on the first image frames in the image list to obtain faces with a face detection area larger than a set value, a plurality of image lists are obtained by tracking the faces according to face features and dividing image frames into groups according to face identifications.

At step S403, a respective mouth region picture sequence corresponding to each image list is determined by traversing each image list.

At step S404, it is determined whether the mouth is in a lip-moving state.

It should be noted that the mouth key points are extracted from the mouth region pictures in the mouth region picture sequence, and a motion trajectory of the key points is obtained by tracking the mouth key points. If the motion trajectory exhibits an opening and closing change, it is determined that the mouth is in a lip-moving state.

It should be noted that based on whether the motion trajectory exhibits an opening and closing change, that is, whether the mouth is speaking, it is determined whether the mouth is in a lip-moving state and then the subsequent steps are performed, which is suitable for audio and video synchronization detection in scenarios involving many people.

If it is determined that the motion trajectory exhibits an opening and closing change, that is, the mouth is in a lip-moving state, step S405 is executed.

If it is determined that the motion trajectory does not exhibit an opening and closing change, that is, the mouth is not in a lip-moving state, step S403 is executed.

At step S405, lip motion feature extraction is performed on mouth region pictures corresponding to each image list to obtain a respective lip motion feature sequence corresponding to each image list, and the respective lip motion feature sequence corresponding to each image list and an audio feature sequence are input into a pre-trained labial-sound synchronization detection model for cross-modal similarity calculation to obtain a respective labial-sound similarity corresponding to each image list.

It should be noted that the labial-sound synchronization detection model is used for cross-modal similarity calculation between the lip motion feature sequence and the audio feature sequence, and the audio and video synchronization detection is realized according to the labial-sound similarities, which improves the accuracy of the audio and video synchronization detection result.

At step S406, audio and video synchronization detection is performed on the video, i.e., it is determined whether the video is audio-video synchronized, according to the respective labial-sound similarity corresponding to each image list.

At step S407, in response to a statistical count of image lists whose labial-sound similarity is greater than or equal to a similarity threshold being greater than or equal to a quantity threshold, the video is determined to be audio-video synchronized.

At step S408, in response to the statistical count of image lists whose labial-sound similarity is greater than or equal to the similarity threshold being less than the quantity threshold, the video is determined to be audio-video unsynchronized.

In conclusion, the audio and video synchronization detection method provided in the disclosure determines the labial-sound synchronization detection algorithm as the target audio and video synchronization detection algorithm if it determines that there are no subtitles in the first image frames. The image frames are divided into groups by face identifications to obtain the image lists, which solves the problem of audio and video synchronization detection in scenarios involving many people. According to the respective labial-sound similarities corresponding to the image lists, the audio and video synchronization detection is performed on the video, which avoids the problem of miss detection in the process of audio and video synchronization detection, prevents the problem of secondary detection caused by miss detection in the previous process, reduces the cost in the process of audio and video synchronization detection, improves the efficiency of audio and video synchronization detection, ensures the accuracy and reliability of the audio and video synchronization detection result of the video, and improves user experience when watching the video.

In the technical solution of the disclosure, the collection, storage, use, processing, transmission, provision and disclosure of personal information of users all comply with the provisions of relevant laws and regulations, and do not violate public order and good customs.

According to the embodiments of the disclosure, the disclosure also provides an audio and video synchronization detection apparatus for implementing the audio and video synchronization detection method.

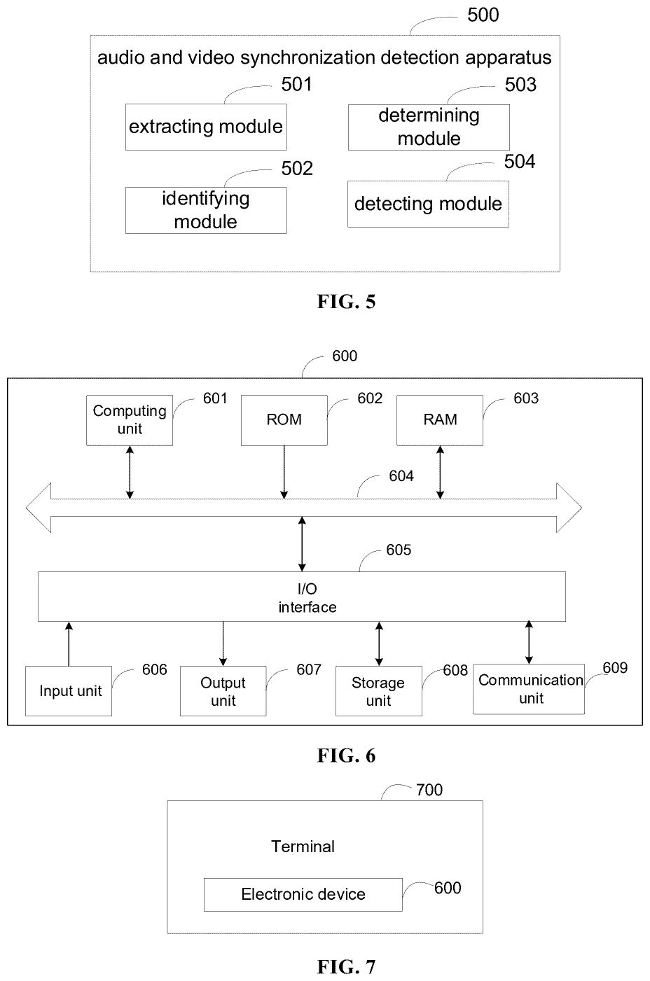

FIG. 5 is a schematic diagram of an audio and video synchronization detection apparatus of an embodiment of the disclosure.

As illustrated in FIG. 5, the audio and video synchronization detection apparatus 500 includes: an extracting module 501, an identifying module 502, a determining module 503 and a detecting module 504.

The extracting module 501 is configured to extract first image frames and first audio frames from a video.

The identifying module 502 is configured to obtain a respective target type of each first image frame by identifying types of the first image frames.

The determining module 503 is configured to determine a respective target audio and video synchronization detection algorithm according to the respective target type.

The detecting module 504 is configured to perform audio and video synchronization detection on the first image frames and the first audio frames based on the respective target audio and video synchronization detection algorithms.

In an embodiment of the disclosure, the identifying module 502 is further configured to: determine whether each first image frame contains a subtitle by performing content recognition on the first image frame; in response to the first image frame containing the subtitle, determine that the target type of the first image frame is a first type; and in response to the first image frame not containing the subtitle, determine that the target type of the first image frame is a second type.

In an embodiment of the disclosure, the determining module 503 is further configured to: in response to the target type being the first type, determine a subtitle-audio synchronization detection algorithm as the target audio and video synchronization detection algorithm; and in response to the target type being the second type, determine a labial-sound synchronization detection algorithm as the target audio and video synchronization detection algorithm.

In an embodiment of the disclosure, in a case that the target audio and video synchronization detection algorithm is the subtitle-audio synchronization detection algorithm, the detecting module 504 is further configured to: determine at least one second image frame with the same subtitle from the first image frames; determine a respective timestamp of each second image frame and timestamps of the first audio frames; determine a start timestamp and an end timestamp of the same subtitle according to the respective timestamp of each second image frame; and determine second audio frames synchronized with the second image frames from the first audio frames according to the start timestamp, the end timestamp and the timestamps of the first audio frames; obtain an audio recognition result of the second audio frames; and perform audio and video synchronization detection on the first image frames and the first audio frames according to the same subtitle and the audio recognition result.

In an embodiment of the disclosure, the detecting module 504 is further configured to: extract contents of the subtitles of the first image frames, determine the second image frames with the same subtitle; and obtain an image frame sequence by ranking the second image frames according to the respective timestamp of each second image frame.

In an embodiment of the disclosure, in a case that the target audio and video synchronization detection algorithm is the labial-sound synchronization detection algorithm, the detecting module 504 is further configured to: obtain one or more face identifications by performing face detection and tracking on the first image frames, and obtain a plurality of image lists by dividing the first image frames into groups according to the face identifications; determine, for each image list, mouth region pictures corresponding to the image list according to the first image frames in the image list; and perform audio and video synchronization detection on the mouth region pictures corresponding to image lists and the first audio frames.

In an embodiment of the disclosure, the detecting module 504 is further configured to: obtain a first audio frame sequence by ranking the first audio frames according to the timestamps of the first audio frames; obtain an audio feature sequence by extracting audio features of the first audio frame sequence; obtain a respective mouth region picture sequence by ranking the mouth region pictures corresponding to each image list according to timestamps; and obtain a respective lip motion feature sequence corresponding to each image list by extracting lip motion features of the respective mouth region picture sequence; obtain a respective labial-sound similarity corresponding to each image list according to the respective lip motion feature sequence corresponding to each image list and the audio feature sequence; and perform audio and video synchronization detection on the video according to the respective labial-sound similarities corresponding to the image lists.

In an embodiment of the disclosure, the apparatus 500 is further configured to: extract mouth key points from the mouth region pictures in the mouth region picture sequence, and obtain a motion trajectory of the key points by tracking the mouth key points; and if the motion trajectory exhibits an opening and closing change, determine that the mouth is in a lip-moving state.

The audio and video synchronization detection apparatus provided in the disclosure extracts the first image frames and the first audio frames from the video, identifies the types of the first image frames to obtain the respective target type of each first image frame, determines the respective target audio and video synchronization detection algorithm according to the respective target type, and performs audio and video synchronization detection on the first image frames and the first audio frames based on the target audio-visual synchronization detection algorithms. By determining whether there is a subtitle in the first image frame, the disclosure may obtain the target type of the image frame and determine the target audio and video synchronization detection algorithm according to the target type of the image frame, which improves the flexibility and applicability of obtaining the audio and video synchronization detection result of the video. The audio and video synchronization detection is performed on the first image frames and the first audio frames based on the target audio and video synchronization detection algorithms, which improves the accuracy and reliability of obtaining the audio and video synchronization detection result of the video.

According to the embodiments of the disclosure, the disclosure also provides an electronic device, a terminal and a computer program product.

FIG. 6 is a schematic block diagram of an example electronic device 600 that can be used to implement the embodiment of the disclosure. The electronic device is intended to represent various forms of digital computers, such as a laptop computer, a desktop computer, a workbench, a personal digital assistant, a server, a blade server, a mainframe computer and other suitable computers. The electronic device may also represent various forms of mobile devices, such as a personal digital processor, a cellular phone, a smart phone, a wearable device and other similar computing devices. The components shown here, their connections and relations, and their functions are merely exemplary, and are not intended to limit the implementation of the disclosure described and/or required herein.

As illustrated in FIG. 6, the device 600 includes: a computing unit 601 for performing various appropriate actions and processes according to computer programs stored in a Read-Only Memory (ROM) 602 or computer programs loaded from a storage unit 608 to a Random Access Memory (RAM) 603. The RAM 603 may also stores necessary programs and data for the device 600 to operate. The computing unit 601, the ROM 602 and the RAM 603 are connected to each other through a bus 604. An input/output (I/O) interface 605 is also connected to the bus 604.

Components in the device 600 are connected to the I/O interface 605, including: an input unit 606, such as a keyboard and a mouse; an output unit 607, such as various types of displays and speakers; the storage unit 608, such as a disk and an optical disk; and a communication unit 609, such as a network card, a modem and a wireless communication transceiver. The communication unit 609 allows the device 600 to exchange information/data with other devices through a computer network such as the Internet and/or various telecommunication networks.

The computing unit 601 may be various general-purpose and/or dedicated processing components having processing and computing capabilities. Some examples of the computing unit 601 include, but are not limited to, a Central Processing Unit (CPU), a Graphics Processing Unit (GPU), various dedicated AI computing chips, various computing units that run machine learning (ML) model algorithms, a Digital Signal Processor (DSP) and any appropriate processor, controller or microcontroller. The computing unit 601 executes the various methods and processes described above, such as the sound and picture synchronization detection method. For example, in some embodiments, the above method may be implemented as a computer software program, which is tangibly contained in a machine readable medium, such as the storage unit 608. In some embodiments, part or all of the computer programs may be loaded and/or installed on the device 600 via the ROM 602 and/or the communication unit 609. When the computer program is loaded on the RAM 603 and executed by the computing unit 601, one or more steps of the above method may be executed. Alternatively, in other embodiments, the computing unit 601 may be configured to perform the above method in any other suitable manner (for example, by means of firmware).

Various implementations of the systems and techniques described above may be implemented by a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware/firmware/software, and/or any combination thereof. These implementations may be implemented in one or more computer programs, the one or more computer programs may be executed and/or interpreted on a programmable system including at least one programmable processor, which may be a dedicated or general programmable processor for receiving data and instructions from a storage system, at least one input device and at least one output device, and transmitting data and instructions to the storage system, the at least one input device and the at least one output device.

The program code configured to implement the method of the disclosure may be written in any combination of one or more programming languages. These program codes may be provided to a processor/controller of a general-purpose computer, a dedicated computer or any other programmable data processing device, so that when the program code is executed by the processor/controller, the functions/operations specified in the flowchart and/or block diagram can be implemented. The program code may be executed entirely on the machine, partly executed on the machine, partly executed on the machine and partly executed on the remote machine as an independent software package or entirely executed on the remote machine or server.

In the context of the disclosure, a machine-readable medium may be a tangible medium that may contain or store a program for use by or in combination with an instruction execution system, an apparatus, or a device. The machine-readable medium may be a machine-readable signal medium or a machine-readable storage medium. The machine-readable medium may include, but is not limited to, an electronic, magnetic, optical, electromagnetic, infrared, or semiconductor system/apparatus/device, or any suitable combination of the above. More specific examples of the machine-readable storage medium include electrical connections based on one or more wires, portable computer disks, hard disks, RAMs, ROMs, Electrically Programmable Read-Only-Memories (EPROMs) or flash memories, fiber optics, Compact Disc Read-Only Memories (CD-ROMs), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor) for displaying information to a user; and a keyboard and a pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback or haptic feedback), and the input from the user may be received in any form (including acoustic input, voice input or tactile input).

The systems and technologies described herein can be implemented in a computing system that includes back-end components (for example, a data server), or a computing system that includes middleware components (for example, an application server), or a computing system that includes front-end components (for example, a user computer with a graphical user interface or a web browser, through which the user can interact with the implementations of the systems and technologies described herein), or a computing system that includes any combination of such back-end components, middleware components and front-end components. The components of the system may be interconnected by any form or medium of digital data communication (e.g., a communication network). The communication network may include, for example, a Local Area Network (LAN), a Wide Area Network (WAN), and the Internet.

The computer system may include a client and a server. The client and the server are generally remote from each other and interacting through a communication network. The client-server relation is generated by computer programs running on the respective computers and having a client-server relation with each other. The server may be a cloud server, a server with a distributed system, or a server combined with a block-chain.

According to the embodiment of the disclosure, the disclosure also provides a terminal 700. As illustrated in FIG. 7, the terminal 700 includes the electronic device 600 described above.

According to the embodiment of the disclosure, the disclosure also provides a computer program product including a computer program. When the computer program is executed by a processor, the steps of the sound and picture synchronization detection method described in the above embodiments of the disclosure.

It is understandable that the steps can be reordered, added or deleted using various forms of the processes shown above. For example, the steps in the disclosure may be performed in parallel or sequentially or in different orders, as long as the desired results of the technical solutions disclosed in the disclosure are achieved, which is not limited herein.

The specific embodiments described above do not constitute a limitation on the scope of protection of the disclosure. It should be understood by those skilled in the art that various modifications, combinations, sub-combinations and substitutions can be made depending on the design requirements and other factors. Any modifications, equivalent substitutions and improvements made within the spirit and principles of the disclosure shall be included in the scope of protection of the disclosure.

What is claimed is:

1. An audio and video synchronization detection method, comprising:
extracting first image frames and first audio frames from a video;
obtaining a respective target type of each first image frame by identifying types of the first image frames;
determining a respective target audio and video synchronization detection algorithm according to the respective target type; and
performing audio and video synchronization detection on the first image frames and the first audio frames based on the target audio and video synchronization detection algorithms.

2. The method of claim 1, wherein obtaining the respective target type of each first image frame by identifying the types of the first image frames, comprises:
determining whether each first image frame contains a subtitle by performing content recognition on the first image frame;
in response to the first image frame containing the subtitle, determining that the target type of the first image frame is a first type; and
in response to the first image frame not containing the subtitle, determining that the target type of the first image frame is a second type.

3. The method of claim 2, wherein determining the respective target audio and video synchronization detection algorithm according to the respective target type, comprises:
in response to the target type being the first type, determining a subtitle-audio synchronization detection algorithm as the target audio and video synchronization detection algorithm; and
in response to the target type being the second type, determining a labial-sound synchronization detection algorithm as the target audio and video synchronization detection algorithm.

4. The method of claim 3, wherein in a case that the target audio and video synchronization detection algorithm is the subtitle-audio synchronization detection algorithm, performing the audio and video synchronization detection on the first image frames and the first audio frames based on the target audio and video synchronization detection algorithms, comprises:
determining at least one second image frame with the same subtitle from the first image frames;
determining at least one second audio frame synchronized with the at least one second image frame from the first audio frames;
obtaining an audio recognition result of the at least one second audio frame; and
performing the audio and video synchronization detection on the first image frames and the first audio frames according to the same subtitle and the audio recognition result.

5. The method of claim 4, wherein determining the at least one second image frame with the same subtitle from the first image frames, comprises:
extracting contents of subtitles of the first image frames, and determining the at least one second image frame with the same subtitle; and
obtaining an image frame sequence by ranking the at least one second image frame according to a respective timestamp of each second image frame.

6. The method of claim 4, wherein determining the at least one second audio frame synchronized with the at least one second image frame from the first audio frames, comprises:
determining a respective timestamp of each second image frame and timestamps of the first audio frames;
determining start and end timestamps of the same subtitle according to the respective timestamp of each second image frame; and
determining the at least one second audio frame synchronized with the at least one second image frame from the first audio frames according to the start timestamp, the end timestamp and the timestamps of the first audio frames.

7. The method of claim 3, wherein in a case that the target audio and video synchronization detection algorithm is the labial-sound synchronization detection algorithm, performing the audio and video synchronization detection on the first image frames and the first audio frames based on the target audio and video synchronization detection algorithms, comprises:
obtaining one or more face identifications by performing face detection and tracking on the first image frames, and obtaining a plurality of image lists by dividing the first image frames into groups according to the face identifications;
determining respective mouth region pictures corresponding to each image list according to first image frames in each image list; and
performing the audio and video synchronization detection on the respective mouth region pictures corresponding to each image list and the first audio frames.

8. The method of claim 7, wherein performing the audio and video synchronization detection on the respective mouth region pictures corresponding to each image list and the first audio frames, comprises:
obtaining an audio feature sequence of the first audio frames by extracting audio features of the first audio frames;
obtaining a lip motion feature sequence corresponding to the image list by extracting lip motion features from the mouth region pictures corresponding to the image list;
obtaining a labial-sound similarity corresponding to the image list according to the lip motion feature sequence corresponding to the image list and the audio feature sequence; and
performing the audio and video synchronization detection on the video according to the labial-sound similarities corresponding to the image lists.

9. The method of claim 8, wherein obtaining the lip motion feature sequence corresponding to the image list by extracting the lip motion features from the mouth area pictures corresponding to the image list, comprises:
obtaining a mouth region picture sequence by ranking the mouth region pictures corresponding to the image list according to timestamps; and
obtaining the lip motion feature sequence corresponding to the image list by extracting lip motion features of the mouth region picture sequence.

10. The method of claim 8, wherein obtaining the audio feature sequence of the first audio frames by extracting the audio features of the first audio frames, comprises:
obtaining a first audio frame sequence by ranking the first audio frames according to the timestamps of the first audio frames; and
obtaining the audio feature sequence by extracting audio features of the first audio frame sequence.

11. The method of claim 9, wherein before obtaining the audio feature sequence of the first audio frames by extracting the audio features of the first audio frames, the method further comprises:
extracting mouth key points from the mouth region pictures in the mouth region picture sequence, and obtaining a motion trajectory of key points by tracking the mouth key points; and
in a case that the motion trajectory exhibits an opening and closing change, determining that the mouth is in a lip-moving state.

12. An electronic device, comprising a processor and a memory;
wherein the processor reads an executable program code stored in the memory and runs a program corresponding to the executable program code, to enable the processor to:
extract first image frames and first audio frames from a video;
obtain a respective target type of each first image frame by identifying types of the first image frames;
determine a respective target audio and video synchronization detection algorithm according to the respective target type; and
perform audio and video synchronization detection on the first image frames and the first audio frames based on the target audio and video synchronization detection algorithms.

13. The electronic device of claim 12, wherein the processor is configured to:
determine whether each first image frame contains a subtitle by performing content recognition on the first image frame;
in response to the first image frame containing the subtitle, determine that the target type of the first image frame is a first type; and
in response to the first image frame not containing the subtitle, determine that the target type of the first image frame is a second type.

14. The electronic device of claim 13, wherein the processor is configured to:
in response to the target type being the first type, determine a subtitle-audio synchronization detection algorithm as the target audio and video synchronization detection algorithm; and
in response to the target type being the second type, determine a labial-sound synchronization detection algorithm as the target audio and video synchronization detection algorithm.

15. The electronic device of claim 14, wherein in a case that the target audio and video synchronization detection algorithm is the subtitle-audio synchronization detection algorithm, the processor is configured to:
determine at least one second image frame with the same subtitle from the first image frames;
determine at least one second audio frame synchronized with the at least one second image frame from the first audio frames;
obtain an audio recognition result of the at least one second audio frame; and
perform the audio and video synchronization detection on the first image frames and the first audio frames according to the same subtitle and the audio recognition result.

16. The electronic device of claim 15, wherein the processor is configured to:
extract contents of subtitles of the first image frames, and determine the at least one second image frame with the same subtitle; and
obtain an image frame sequence by ranking the at least one second image frame according to a respective timestamp of each second image frame.

17. The electronic device of claim 15, wherein the processor is configured to:
determine a respective timestamp of each second image frame and timestamps of the first audio frames;
determine start and end timestamps of the same subtitle according to the respective timestamp of each second image frame; and
determine the at least one second audio frame synchronized with the at least one second image frame from the first audio frames according to the start timestamp, the end timestamp and the timestamps of the first audio frames.

18. The electronic device of claim 14, wherein in a case that the target audio and video synchronization detection algorithm is the labial-sound synchronization detection algorithm, the processor is configured to:
obtain one or more face identifications by performing face detection and tracking on the first image frames, and obtain a plurality of image lists by dividing the first image frames into groups according to the face identifications;
determine respective mouth region pictures corresponding to each image list according to first image frames in each image list; and
perform the audio and video synchronization detection on the respective mouth region pictures corresponding to each image list and the first audio frames.

19. The electronic device of claim 18, wherein the processor is configured to:
obtain an audio feature sequence of the first audio frames by extracting audio features of the first audio frames;
obtain a lip motion feature sequence corresponding to the image list by extracting lip motion features from the mouth region pictures corresponding to the image list;
obtain a labial-sound similarity corresponding to the image list according to the lip motion feature sequence corresponding to the image list and the audio feature sequence; and
perform the audio and video synchronization detection on the video according to the labial-sound similarities corresponding to the image lists.

20. A non-transitory computer readable storage medium having computer instructions stored thereon, wherein the computer instructions are used to cause a computer to:
extract first image frames and first audio frames from a video;
obtain a respective target type of each first image frame by identifying types of the first image frames;
determine a respective target audio and video synchronization detection algorithm according to the respective target type; and
perform audio and video synchronization detection on the first image frames and the first audio frames based on the target audio and video synchronization detection algorithms.
